(19) United States
(12) Patent Application Publication
(10) Pub. No.: US 2024/0104455 A1
(43) Pub. Date: Mar. 28, 2024

(54) INFORMATION PROCESSING APPARATUS, INFORMATION PROCESSING METHOD, AND NON-TRANSITORY COMPUTER-READABLE STORAGE MEDIUM

(71) Applicant: NEC Corporation, Tokyo (JP)

(72) Inventor: Kazuya Kawakami, Tokyo (JP)

(73) Assignee: NEC Corporation, Tokyo (JP)

(21) Appl. No.: 18/225,411

(22) Filed: Jul. 24, 2023

(30) Foreign Application Priority Data
Sep. 28, 2022 (JP) 2022-154530

(51) Int. Cl. G06Q 10/0631

(52) U.S. Cl. CPC G06Q 10/063112; G06Q 10/06315; G06F 21/32

(57) ABSTRACT

An information processing apparatus includes: a generation unit that, for at least one of a plurality of sites, generates estimation information indicating estimated ability of the site by using ability information of an employee at the site and equipment information about equipment at the site; and an output processing unit that generates advice information to a manager of the site by using the estimation information and request information indicating ability requested with regard to the site and causes an output apparatus to output the generated advice information.

This application is based upon and claims the benefit of priority from Japanese Patent Application No. 2022-154530 filed on Sep. 28, 2022, the disclosure of which is incorporated herein in its entirety by reference.

### TECHNICAL FIELD

The present invention relates to an information processing apparatus, an information processing method, and a program.

### BACKGROUND ART

Assistance systems for efficiently performing personnel placement of workers are described in literatures.

For example, Japanese Patent Application Publication No. 2020-173537 (PTL 1) describes a personnel placement assistance system that acquires working hours required for work in each of a plurality of processes, evaluates working ability of a worker in stages, based on the acquired working hours, stores the evaluation result into a database for each worker as personal ability data, and places workers in a plurality of processes with reference to the database.

Japanese Patent Application Publication No. 2020-173536 (PTL 2) describes an organizational ability evaluation system that can suitably evaluate working ability of a worker and stabilize productivity in an organization at a high level by acquiring working hours required for work in each of a plurality of processes as a track record of work, storing standard working hours set for each process as an evaluation criterion when a track record of work is evaluated, computing working ability for each process, based on the per-process track record of work and the standard working hours, storing the computed working ability for each process as a per-process working ability, and computing organizational ability for each process, based on the per-process working ability.

Japanese Patent Application Publication No. 2003-242339 (PTL 3) describes a system that provides optimum advice on employee selection for employee selection in organization formation by determining excess or deficiency of organizational ability by comparison with a total amount of ability in an organizational mission from a combination of executor (subordinate) ability types in business in addition to a communicator (superior) factor in business.

Japanese Patent Application Publication No. 2020-91643 (PTL 4) describes a system that, by detecting processing ability of an operator working at manufacturing equipment installed on a floor by the manufacturing equipment and managing processing ability of the manufacturing equipment and the operator with the manufacturing equipment and the operator as surveillance targets, performs personnel placement in consideration of the processing ability of the manufacturing equipment and the operator, causes the manufacturing equipment and the operator to mutually bring out the processing ability, and improves productivity.

International Application Publication No. WO 2021/75562 (PTL 5) describes an information processing system that accumulates history information including at least either of knowledge and use experience of an industrial machine, the information being possessed by a person operating the industrial machine, as personal ability information in association with personal identification information for determining the person, analyzes the personal ability information, and derives a skill level of the person related to operation of the industrial machine.

Japanese Patent Application Publication No. 2021-157688 (PTL 6) describes a system that properly provides assistance to ability matching between a person who can provide ability and a person in need of ability by registering personal ability of a first user and equipment ability of equipment possessed by the first user, registering at least either of personal ability and equipment ability required by a second user, comparing the registered contents, and based on the comparison result, determining whether the first user can contribute to the second user by providing ability.

Japanese Patent Application Publication No. 2002-41727 (PTL 7) describes a system that includes, on a mediation server machine side, a personal database for an engineer or a specialist storing work skill data and job skill data for each person holding a job as an engineer or a specialist, and an enterprise database storing personnel ability, organizational ability, and a project content of an enterprise, and, by searching the personal database and the enterprise database and using the Internet, enables execution of an outsourcing service related to ability diagnosis and determination, counseling, consulting, personnel registration, and personnel utilization for each person holding a job as an engineer or a specialist, and an outsourcing service related to ability diagnosis and evaluation, management counseling, personnel consulting, personnel ability, an organizational ability, and a project content for the enterprise.

### SUMMARY

Each of the technologies described in the aforementioned patent literatures relates to a system that provides assistance to distribution and placement of employee ability in a certain enterprise or a certain organization. Therefore, the technology described in each patent literature cannot provide assistance to distribution and placement of ability of equipment and employees by adjusting excess or deficiency of ability, in consideration of organizational strength of the organization as a whole. On the other hand, the present inventor has examined a system that enables improved productivity in an organization as a whole and enhanced organizational strength by efficiently performing distribution and placement of ability of equipment and employees by adjusting excess or deficiency of ability, in consideration of organizational strength of the organization as a whole.

An example of an object of the present invention is to, in view of the aforementioned issue, provide an information processing apparatus, an information processing method, and a program that resolve the issue of not being able to provide assistance to distribution and placement of ability of equipment and employees by adjusting excess or deficiency of ability, in consideration of organizational strength of an organization as a whole.

According to an example aspect of the present invention, an information processing apparatus including:
at least one memory configured to store instructions; and
at least one processor configured to execute the instructions to:
for at least one of a plurality of sites, generate estimation information indicating estimated ability of the site by using ability information of an employee at the site and equipment information about equipment at the site; and
generate advice information to a manager of the site by using the estimation information and request information indicating ability requested with regard to the site and cause an output unit to output the generated advice information.

According to an example aspect of the present invention, an information processing method including, by at least one computer:
for at least one of a plurality of sites, generating estimation information indicating estimated ability of the site by using ability information of an employee at the site and equipment information about equipment at the site; and
generating advice information to a manager of the site by using the estimation information and request information indicating ability requested with regard to the site and causing an output unit to output the generated information is provided.

According to an example aspect of the present invention, a program for causing a computer to execute:
a procedure for, for at least one of a plurality of sites, generating estimation information indicating estimated ability of the site by using ability information of an employee at the site and equipment information about equipment at the site; and
a procedure for generating advice information to a manager of the site by using the estimation information and request information indicating ability requested with regard to the site and causing an output unit to output the generated information is provided.

Note that another example aspect of the present invention may be a program causing at least one computer to execute the method according to the aforementioned aspect or may be a computer-readable storage medium on which such a program is recorded. The storage medium includes a non-transitory tangible medium.

The computer program includes a computer program code causing a computer to implement the information processing method on an information processing apparatus when being executed by the computer.

Note that any combination of the components described above, and representations of the present invention converted between a method, an apparatus, a system, a storage medium, a computer program, and the like are also valid as embodiments of the present invention.

Further, various components of the present invention do not necessarily need to be individually independent, and for example, a plurality of components may be formed as a single member, a plurality of members may form a single component, a certain component may be part of another component, and part of a certain component may overlap with part of another component.

Further, while a plurality of procedures are described in a sequential order in the method and the computer program according to the present invention, the order of description does not limit the order in which the plurality of procedures are executed. Therefore, when the method and the computer program according to the present invention are implemented, the order of the plurality of procedures may be changed without affecting the contents.

Furthermore, a plurality of procedures in the method and the computer program according to the present invention are not limited to be executed at timings different from each other. Therefore, for example, a certain procedure may be executed during execution of another procedure, and an execution timing of a certain procedure and an execution timing of another procedure may overlap with each other in part or in whole.

An example advantage according to the invention is that an information processing apparatus, an information processing method, and a program that enable improved productivity in an organization as a whole and enhanced organizational strength by efficiently performing distribution and placement of ability of equipment and employees by adjusting excess or deficiency of ability, in consideration of organizational strength of the organization as a whole, can be provided.

### BRIEF DESCRIPTION OF THE DRAWINGS

FIG. 1 is a diagram illustrating an overview of an information processing apparatus according to an example embodiment.

FIG. 2 is a flowchart illustrating an operation example of the information processing apparatus according to the example embodiment.

FIG. 3 is a diagram conceptually illustrating a system configuration of an information processing system according to a first example embodiment.

FIG. 4 is a block diagram illustrating a hardware configuration of a computer providing an information processing apparatus.

FIG. 5 is a diagram illustrating a data structure example of site information.

FIGS. 6A and 6B are diagrams illustrating data structure examples of employee ability information and equipment information, respectively.

FIG. 7 is a diagram illustrating another data structure example of equipment information.

FIG. 8 is a flowchart illustrating an operation example of an information processing apparatus according to a second example embodiment.

FIG. 9 is a functional block diagram illustrating a functional configuration example of an information processing apparatus according to a third example embodiment.

FIG. 10 is a diagram illustrating a data structure example of site information.

FIG. 11 is a flowchart illustrating an operation example of the information processing apparatus according to the third example embodiment.

FIG. 12 is a diagram illustrating an overview of an information processing apparatus according to a fourth example embodiment.

FIG. 13 is a diagram conceptually illustrating a system configuration of an information processing system according to the fourth example embodiment.

FIG. 14 is a diagram illustrating a data structure example of market information.

FIG. 15 is a flowchart illustrating an operation example of the information processing apparatus according to the fourth example embodiment.

FIG. 16 is a diagram illustrating an overview of an information processing apparatus according to a fifth example embodiment.

FIG. 17 is a diagram conceptually illustrating a system configuration of an information processing system according to the fifth example embodiment.

FIG. 18 is a diagram illustrating a data structure example of employee ability information.

FIG. 19 is a flowchart illustrating an operation example of the information processing apparatus according to the fifth example embodiment.

### EXAMPLE EMBODIMENT

Example embodiments will be described below by using drawings. Note that in every drawings, similar components are given similar signs, and description thereof is not included as appropriate. Further, in each of the following diagrams, a configuration of a part not related to the essence of the example embodiments is not included and is not illustrated.

In the example embodiments, “acquisition” includes at least either of an apparatus getting data or information stored in another apparatus or a storage medium (active acquisition), and an apparatus inputting data or information output from another apparatus to the apparatus (passive acquisition). Examples of the active acquisition include making a request or an inquiry to another apparatus and receiving a response, and readout by accessing another apparatus or a storage medium. Further, examples of the passive acquisition include reception of distributed (or, for example, transmitted or push notified) information. Furthermore, “acquisition” may refer to selective acquisition from received data or information, or selective reception of distributed data or information.

### Minimum Configuration Example

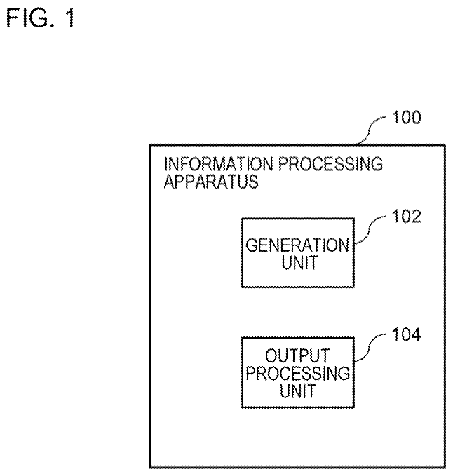

FIG. 1 is a diagram illustrating an overview of an information processing apparatus 100 according to an example embodiment. The information processing apparatus 100 includes a generation unit 102 and an output processing unit 104.

For at least one of a plurality of sites, the generation unit 102 generates estimation information indicating estimated ability of the site by using ability information of an employee at the site and equipment information about equipment at the site.

The output processing unit 104 generates advice information to a manager of the site by using the estimation information and request information indicating ability requested with regard to the site and causes an output means (for example, an output apparatus such as a display or a printer) to output the generated information.

### Operation Example

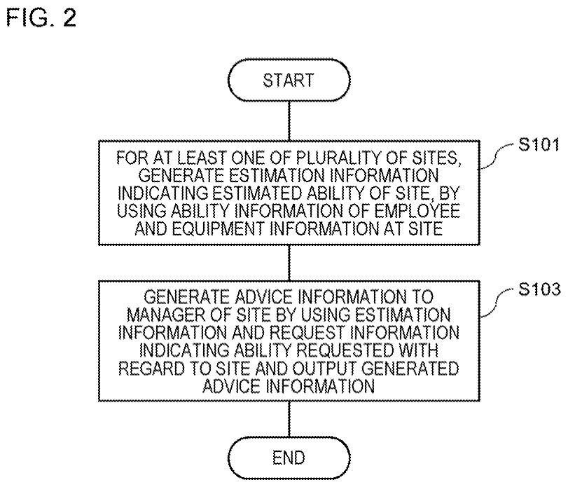

FIG. 2 is a flowchart illustrating an operation example of the information processing apparatus 100 according to the example embodiment.

For at least one of a plurality of sites, the generation unit 102 generates estimation information indicating estimated ability of the site by using ability information of an employee at the site and equipment information about equipment at the site (Step S101).

The output processing unit 104 generates advice information to a manager of the site by using the estimation information and request information indicating ability requested with regard to the site and causes an output apparatus to output the generated information (Step S103).

For at least one of a plurality of sites, the generation unit 102 in the information processing apparatus 100 generates estimation information indicating estimated ability of the site by using ability information of an employee at the site and equipment information about equipment at the site. Then, the output processing unit 104 generates advice information to a manager of the site by using the estimation information and request information indicating ability requested with regard to the site and causes the output apparatus to output the generated information.

Accordingly, the configuration enables improved productivity in an organization as a whole and enhanced organizational strength by efficiently performing distribution and placement of ability of equipment and employees by adjusting excess or deficiency of ability, in consideration of organizational strength of the organization as a whole.

A detailed example of the information processing apparatus 100 will be described below.

### First Example Embodiment

### System Overview

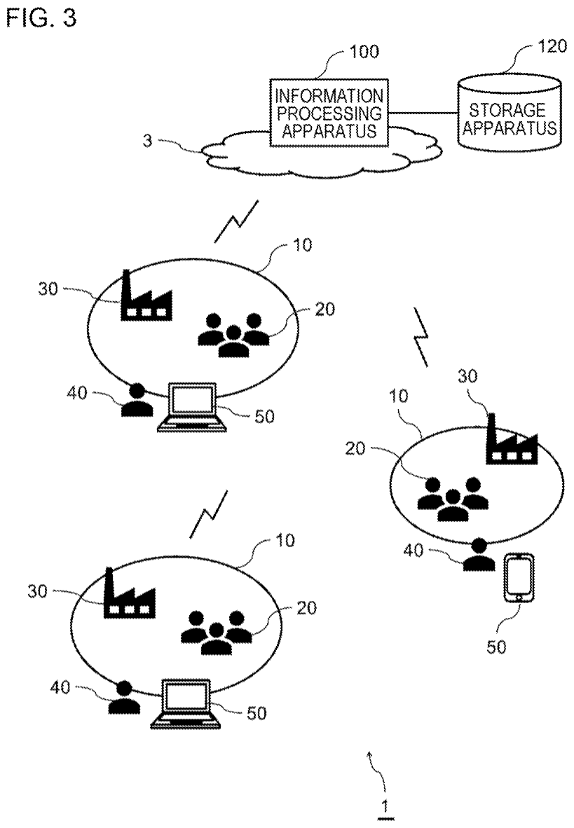

FIG. 3 is a diagram conceptually illustrating a system configuration of an information processing system 1 according to the present example embodiment.

The information processing system 1 includes an information processing apparatus 100. The information processing apparatus 100 processes information of a plurality of sites 10A, 10B, 10C, . . . (the sites are hereinafter simply referred to as sites 10 when not being particularly required to be distinguished). A plurality of employees 20 operating equipment 30 are working at each site 10. Furthermore, at each site 10, the information processing system 1 includes a terminal 50 used by a manager 40 managing the site 10. For example, the site 10 is a facility such as a plant or the like in a manufacturing industry or the like. The plurality of sites 10 may be facilities belonging to the same enterprise or may be facilities belonging to enterprises different from each other.

The information processing apparatus 100 is connected to the terminal 50 through a communication network 3. The information processing apparatus 100 is a computer such as a server computer. The information processing apparatus 100 includes a storage apparatus 120. The storage apparatus 120 may be provided inside the information processing apparatus 100 or outside the information processing apparatus 100. In other words, the storage apparatus 120 may be hardware integrated with the information processing apparatus 100 or hardware separate from the information processing apparatus 100.

Examples of the terminal 50 include computers such as a personal computer, a smartphone, and a tablet terminal.

For example, a service provided by the information processing system 1 may be used by using each terminal 50. For each terminal 50, registration for use of a service provided by the information processing system 1 is performed in advance, and a user account is acquired. An application for use of the service provided by the information processing system 1, or a browser is launched at each terminal 50, and a uniform resource locator (URL) for use of the service provided by the information processing system 1 is accessed, thereby causing a web page to be displayed. Then, after a login to the information processing system 1 is performed by using the user account, display of advice information may be selected from a menu screen, and the advice information may be displayed on a display of the terminal 50.

For example, each piece of equipment 30 includes a manufacturing line or a manufacturing apparatus in a plant. Furthermore, each piece of equipment 30 is provided with various sensors for detecting a state of the equipment 30, and the information processing apparatus 100 can acquire information indicating the state of the equipment 30.

### Hardware Configuration Example

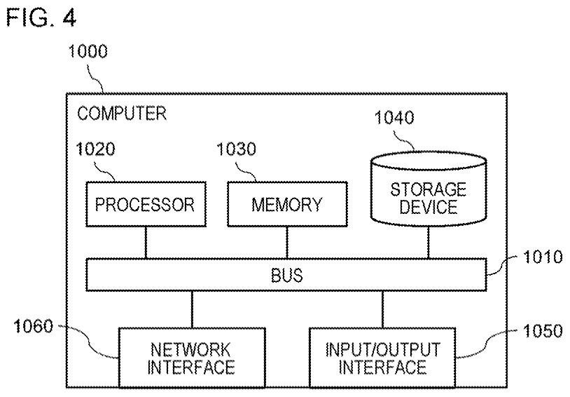

FIG. 4 is a block diagram illustrating a hardware configuration of a computer 1000 providing the information processing apparatus 100. The terminal 50 in FIG. 3 is also provided by the computer 1000.

The computer 1000 includes a bus 1010, a processor 1020, a memory 1030, a storage device 1040, an input/output interface 1050, and a network interface 1060.

The bus 1010 is a data transmission channel for the processor 1020, the memory 1030, the storage device 1040, the input/output interface 1050, and the network interface 1060 to transmit and receive data to and from one another. Note that the method for interconnecting the processor 1020 and other components is not limited to a bus connection.

The processor 1020 is a processor provided by a central processing unit (CPU), a graphics processing unit (GPU), or the like.

The memory 1030 is a main storage provided by using a random-access memory (RAM) or the like.

The storage device 1040 is an auxiliary storage provided by using a hard disk, a solid-state drive (SSD), a memory card, a read-only memory (ROM), or the like. The storage device 1040 stores program modules providing functions (such as the generation unit 102, the output processing unit 104, and a determination unit 106, an estimation unit 110, and an authentication unit 112 to be described later) of the information processing apparatus 100. By reading each program module into the memory 1030 and executing the program module by the processor 1020, each function related to the program module is provided. Further, the storage device 1040 may also store data in the storage apparatus 120 in the information processing apparatus 100.

The program modules may be recorded on a storage medium. A storage medium on which the program modules are recorded includes a non-transitory tangible medium usable by the computer 1000, and program codes readable by the computer 1000 (processor 1020) may be embedded in the medium.

The input/output interface 1050 is an interface for connecting the computer 1000 to various types of input/output equipment. The input/output interface 1050 also functions as a communication interface performing short-distance wireless communication such as Bluetooth (registered trademark) and/or near field communication (NFC).

The network interface 1060 is an interface for connecting the computer 1000 to the communication network 3. Examples of the communication network 3 include a local area network (LAN) and a wide area network (WAN). The method for connecting the network interface 1060 to the communication network 3 may be a wireless connection or a wired connection.

Then, the computer 1000 is connected to required equipment (for example, an operation unit in the computer such as a keyboard, a mouse, a touch pad, a touch panel, and an operation button, a display, a speaker, a microphone, a camera, and a printer) through the input/output interface 1050 or the network interface 1060.

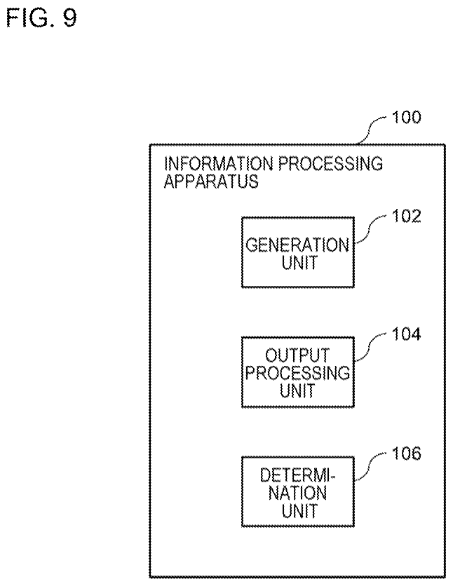

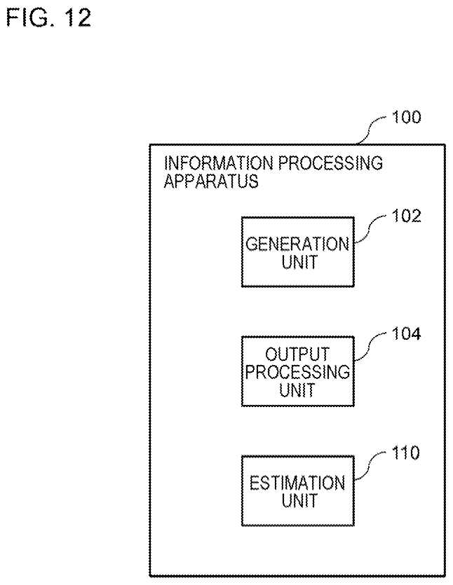

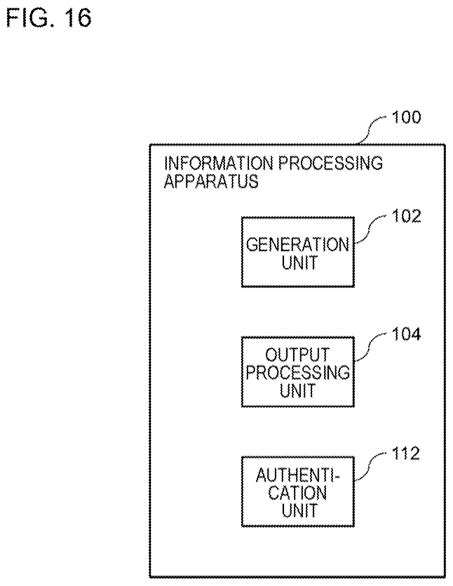

Each component in an information processing apparatus 100 according to each example embodiment in FIG. 1, and FIG. 9, FIG. 12, and FIG. 16 to be described later is provided by any combination of hardware and software in the computer 1000 in FIG. 4. Then, it may be understood by a person skilled in the art that various modifications to the providing method and the apparatus can be made. A functional block diagram illustrating the information processing apparatus 100 according to each example embodiment represents a logical function-based block rather than a hardware-based configuration.

### Functional Configuration Example

A functional configuration example of the information processing apparatus 100 according to the present example embodiment will be described below by using FIG. 1.

For at least one of a plurality of sites 10, the generation unit 102 generates estimation information indicating estimated ability of the site 10 by using ability information of an employee 20 at the site 10 and equipment information about equipment 30 at the site 10.

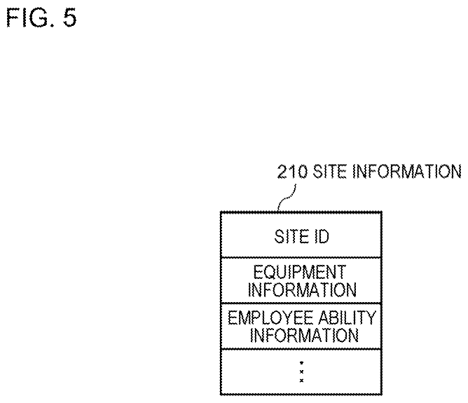

FIG. 5 is a diagram illustrating a data structure example of site information 210.

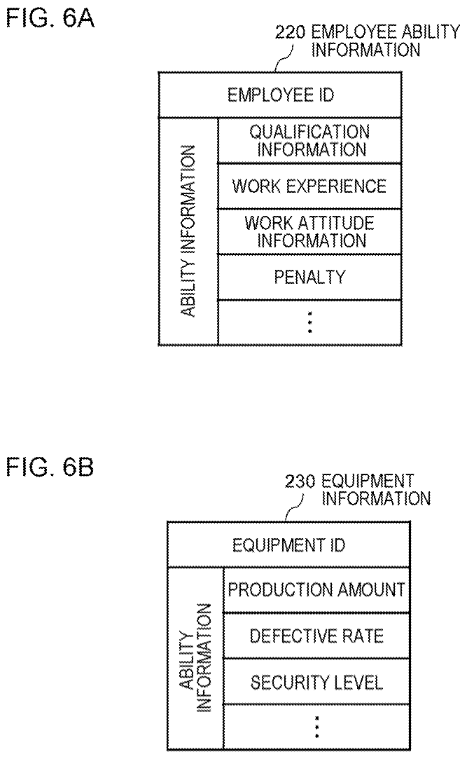

For a plurality of sites, the site information 210 includes identification information (a site ID) for identifying the site, equipment information about the equipment 30, and ability information of an employee 20. The equipment information, and the ability information of an employee 20 specifically include information illustrated in FIGS. 6A and 6B.

FIGS. 6A and 6B are diagrams illustrating data structure examples of employee ability information 220 and equipment information 230, respectively.

The employee ability information 220 of an employee 20 at least includes identification information (an employee ID) for identifying the employee 20 and qualification information indicating a qualification possessed by the employee 20. For example, the qualification information may be information indicating, for each piece of equipment 30, whether the employee 20 possesses a qualification required for operation of the equipment 30, whether the employee 20 can operate the equipment 30 (for example, whether the employee 20 has received study training or hands-on training related to the operation in the company), or the like. Furthermore, the qualification information may include information indicating a track record on duty of confidentiality related to technologies in work, a product, equipment 30, and the like.

Furthermore, the employee ability information 220 may further include information about work experience, work attitude information, and a penalty, as illustrated in FIG. 6A. For example, the work experience includes the number of years or an accumulated time of engagement in the work for each piece of equipment 30 and/or each product. For example, the work attitude information includes information about a length of service, late arrival and early dismissal, and absence. The penalty includes information indicating involvement in occurrence of a substantial delay, a serious mistake, and the like related to the work.

The equipment information 230 includes information indicating a production amount, a defective rate, and a security level of the equipment 30, as illustrated in FIG. 6B. The security level includes information indicating a level of duty of confidentiality (such as existence of duty of confidentiality) related to technologies in work, a product, equipment 30, and the like.

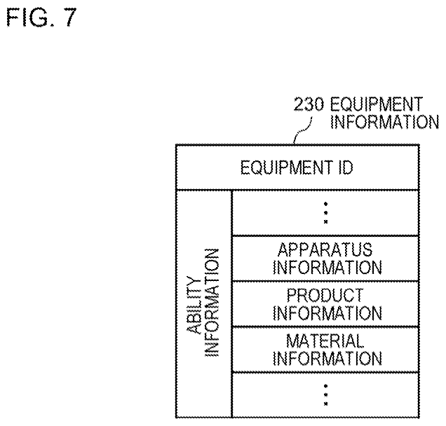

The equipment information 230 further includes, for each piece of equipment 30, apparatus information constituting the equipment 30 and product information related to a product manufactured by the equipment 30, as illustrated in FIG. 7. Furthermore, the equipment information 230 may include material information related to a material required for product manufacture.

For example, the apparatus information includes the type of apparatus, the number of the apparatuses, the number of employees 20 required for operation of the apparatus, qualification information required for operation of the apparatus. The product information includes the product name (model number) and a production amount (for example, on a daily basis). The material information includes a material name (model number) required for product manufacture, a quantity, information about procurement status (information such as a scheduled arrival date may be included in a case of a stockout state). Furthermore, the material information may include information about a cost incurred in procurement of the material.

Furthermore, the material information may include history information about past material procurement such as information about a material price, a procurement source, and a delivery date.

The output processing unit 104 generates advice information to the manager 40 of the site 10 by using the estimation information and request information indicating ability requested with regard to the site 10 and causes an output apparatus (such as a display of the terminal 50 or a printer connected to the terminal 50) to output the generated advice information. Examples of the display of the terminal 50 include a liquid crystal display and an organic electro-luminescence (EL) display.

For example, the request information includes information such as the type of product produced at the site 10, a production amount for each product, and a delivery date.

The advice information includes information indicating the difference between the estimation information and the request information. The information indicating the difference may include at least one type of information out of information indicating the difference between a production amount requested by a delivery date and an estimated production amount, information indicating a shortfall in an estimated production amount relative to a requested amount, and information indicating an excess in an estimated production amount relative to a requested amount. Alternatively, the information indicating the difference may include the difference in days between a requested delivery date and an estimated delivery date for a requested production amount. Alternatively, the information indicating the difference may include information indicating the difference between information indicating at least either of equipment 30 and employees 20 required for producing a requested production amount of products by a delivery date at a certain site 10 and equipment 30 and employees 20 at the certain site 10.

Furthermore, the information indicating the difference may include information indicating the difference between an amount of materials required for producing a requested production amount and a stored amount of materials at the site 10.

For example, the advice information may display estimation information and request information of ability quantified by a graph, a table, or the like in a visually understandable manner. When an estimated result falls short of requested ability, the shortage is preferably highlighted in such a way as to be clearly recognized. On the other hand, when an estimated result exceeds requested ability, the excess may also be highlighted in such a way as to be clearly recognized.

### Operation Example

An operation example of the information processing apparatus 100 according to the present example embodiment will be described below by using FIG. 2.

For at least one of a plurality of sites, the generation unit 102 generates estimation information indicating estimated ability of the site by using ability information of an employee at the site and equipment information about equipment at the site (Step S101).

The output processing unit 104 generates advice information to a manager of the site by using the estimation information and request information indicating ability requested with regard to the site and causes the output apparatus to output the generated advice information (Step S103).

As described above, the information processing apparatus 100 according to the present example embodiment includes the generation unit 102 and the output processing unit 104. For at least one of a plurality of sites, the generation unit 102 generates estimation information indicating estimated ability of the site by using ability information of an employee at the site and equipment information about equipment at the site. The output processing unit 104 generates advice information to a manager of the site by using the estimation information and request information indicating ability requested with regard to the site and causes the output apparatus to output the generated advice information.

Accordingly, by reference to the output advice information, efficient distribution, and placement of ability of equipment and employees can be achieved by adjusting excess or deficiency of ability, in consideration of organizational strength of an organization as a whole, according to the present example embodiment. By extension, improved productivity in the organization as a whole and enhanced organizational strength can be achieved.

### Second Example Embodiment

The present example embodiment is similar to the aforementioned example embodiment except for being configured to, when estimated ability indicated by estimation information of a certain site falls short of ability requested of the certain site, generate estimation information of ability of another site by using information for each of a plurality of sites and cause the generated estimation information to be output. An information processing apparatus 100 according to the present example embodiment has the same configuration as that according to the first example embodiment, and therefore a functional configuration example will be described by using FIG. 1. Note that the configuration according to the present example embodiment may be combined with at least one of configurations according to example embodiments other than the first example embodiment without contradicting each other.

### Functional Configuration Example

A functional configuration example of the information processing apparatus 100 according to the present example embodiment will be described below by using FIG. 1.

For each of a plurality of sites 10, employee ability information 220 of an employee 20 at the site 10 and equipment information 230 at the site 10 are stored in a storage apparatus 120.

When estimated ability indicated by estimation information of a certain site falls short of ability being requested of the certain site and being indicated by request information, a generation unit 102 generates estimation information of another site 10 to be added, by using the information stored in the storage apparatus 120.

An output processing unit 104 causes the estimation information of the another site 10 to be output as at least part of advice information.

The employee ability information 220 according to the present example embodiment may further include information about a work schedule of an employee 20. When the work schedule of an employee 20 at another site 10 has a margin, the generation unit 102 may determine the site 10 to be a candidate of a site 10 to be added. The equipment information 230 may similarly include information about an operation schedule of a line of equipment 30 or a manufacturing apparatus. When the operation schedule of equipment 30 at another site 10 has a margin, the generation unit 102 may determine the site 10 to be a candidate of a site 10 to be added.

As described above, excess or deficiency of estimated ability includes at least one item out of excess or deficiency between a production amount requested by a delivery date and an estimated production amount, the difference in days between a requested delivery date and an estimated delivery date for a requested production amount, at least either of equipment 30 and employees 20 required for producing a requested production amount of products by a delivery date at a certain site 10, and excess or deficiency of at least either of equipment 30 and employees 20 at the certain site 10. Furthermore, excess or deficiency of estimated ability may include excess or deficiency between an amount of materials required for producing a requested production amount and a stored amount of materials at the site 10.

Estimation information of another site 10 output by the output processing unit 104 includes at least one of estimated production amount at the another site 10, an estimated delivery date, and a stored amount of materials with regard to a requested product.

### Operation Example

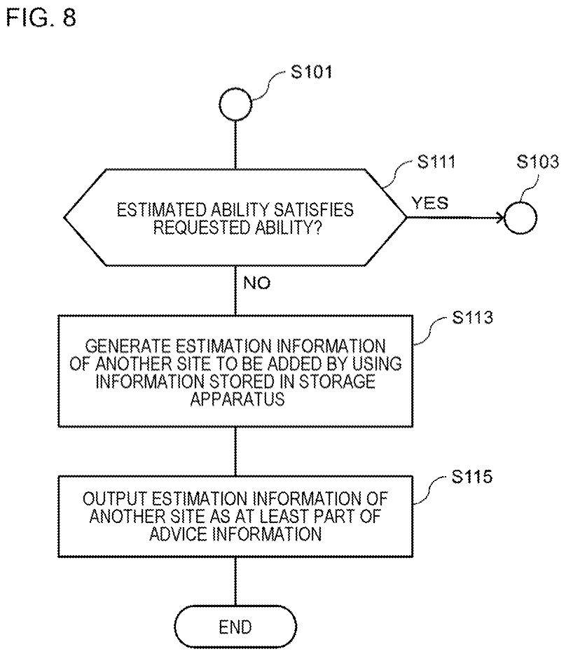

FIG. 8 is a flowchart illustrating an operation example of the information processing apparatus 100 according to the present example embodiment.

This flow is executed after Step S101 in FIG. 2. However, the flow may be executed after Step S103 in FIG. 2. In that case, advice information described in Step S115 in this flow is output in addition to advice information output in Step S103 in FIG. 2.

The generation unit 102 determines whether estimated ability indicated by estimation information of a certain site satisfies ability being requested with regard to the certain site and being indicated by request information (Step S111). When the estimated ability indicated by the estimation information of the certain site does not satisfy the ability being requested with regard to the certain site and being indicated by the request information (NO in Step S111), in other words, when the estimated ability indicated by the estimation information of the certain site falls short of the ability being requested with regard to the certain site and being indicated by the request information, the generation unit 102 generates estimation information of another site 10 by using information stored in the storage apparatus 120 (Step S113).

Then, the output processing unit 104 causes the estimation information of the another site 10 to be output as at least part of the advice information (Step S115).

On the other hand, when the estimated ability indicated by the estimation information of the certain site satisfies the ability being requested with regard to the certain site and being indicated by the request information (YES in Step S111), in other words, when the estimated ability indicated by the estimation information of the certain site does not fall short of the ability being requested with regard to the certain site and being indicated by the request information, the generation unit 102 does not perform Step S113 and Step S115, advances to Step S103 in FIG. 2, generates advice information to the manager 40 of the site 10 by using the estimation information and the request information indicating the ability requested with regard to the certain site 10, and causes the terminal 50 to output the generated advice information.

As described above, for each of a plurality of sites 10, employee ability information 220 of an employee 20 at the site 10 and equipment information 230 of the site 10 are stored in the storage apparatus 120, and the generation unit 102 and the output processing unit 104 are included, according to the present example embodiment. Then, when estimated ability indicated by estimation information of a certain site falls short of ability being requested with regard to the certain site and being indicated by request information, the generation unit 102 generates estimation information of another site 10 to be added, by using the information stored in the storage apparatus 120. The output processing unit 104 causes the estimation information of the another site 10 to be output as at least part of advice information.

Thus, the information processing apparatus 100 according to the present example embodiment provides effects similar to those of the aforementioned example embodiment and can further output estimation information of a certain site 10 for request information and estimation information of another site 10 as advice information, thereby enabling the manager 40 to compare estimation information between the certain site 10 and the another site 10 and examine interchange of ability between the sites 10.

### Third Example Embodiment

FIG. 9 is a functional block diagram illustrating a functional configuration example of an information processing apparatus 100 according to the present example embodiment. The information processing apparatus 100 includes a generation unit 102 and an output processing unit 104 that are the same as those in the information processing apparatus 100 according to the first example embodiment in FIG. 1 and further includes a determination unit 106.

The present example embodiment is similar to the aforementioned second example embodiment except for being configured to determine another site to be added that can provide assistance to a certain site. Note that the configuration according to the present example embodiment may be combined with at least one of configurations according to example embodiments other than the second example embodiment without contradicting each other.

### Functional Configuration Example

The determination unit 106 determines another site to be added that can provide assistance to a certain site 10A, based on request information of the certain site 10A and estimation information of other sites 10B, 10C, and the like.

The output processing unit 104 causes information about the determined another site to be output as at least part of advice information.

Another site to be added refers to a site to be added as a site for producing a product requested of a certain site 10A in order to attain ability requested of the certain site 10A. Information indicating which ability type of the another site 10 is to be added may be included in advice information. For example, the advice information may include information such as equipment 30 to be added at the another site 10, or a manufacturing line, a manufacturing apparatus, employees 20, and materials in equipment 30 that are to be added at the another site 10.

The determination unit 106 determines another site 10 to be added that can provide assistance to a certain site by further using a relationship between sites 10.

For example, a relationship between sites 10 includes a positional relation, a cooperative relation, and the like. For example, the determination unit 106 may determine a site 10 providing a short distance between sites 10 or may determine an easy-to-access site 10. Alternatively, the determination unit 106 may determine a site 10 in a cooperative relation. The determination unit 106 preferably does not determine a site 10 not in a cooperative relation.

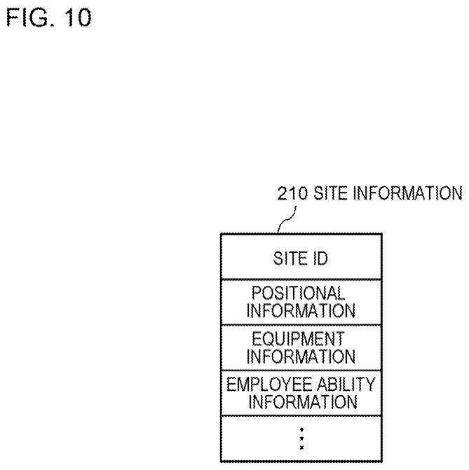

FIG. 10 is a diagram illustrating a data structure example of site information 210. The site information 210 in FIG. 10 further includes positional information of a site 10 in addition to the aforementioned site information 210 in FIG. 5. The positional information may be information indicating a location (such as an address or a region) of the site 10 or may be latitude-longitude.

### Operation Example

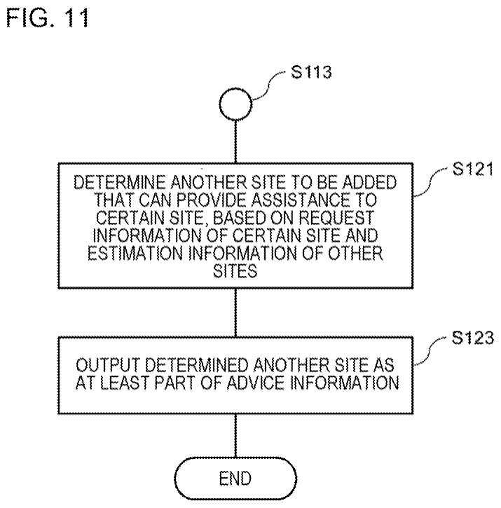

FIG. 11 is a flowchart illustrating an operation example of the information processing apparatus 100 according to the present example embodiment. For example, this flow may be started when a menu for display of advice information is selected on an operation menu on a terminal 50.

The determination unit 106 determines a site to be added that can provide assistance to a certain site 10A, based on request information of the certain site 10A and estimation information of other sites 10B, 10C, and the like (Step S121).

The output processing unit 104 causes information about the determined another site to be output as at least part of advice information (Step S123).

As described above, the information processing apparatus 100 according to the present example embodiment further includes the determination unit 106. The determination unit 106 determines another site to be added that can provide assistance to a certain site 10A, based on request information of the certain site 10A and estimation information of other sites 10B, 10C, and the like. The output processing unit 104 causes information about the determined another site to be output as at least part of advice information.

Thus, the present example embodiment provides effects similar to those of the aforementioned example embodiments and, when ability requested of a certain site 10 is not satisfied, further enables determination and output of another site 10 from which assistance provision can be received; therefore, assistance for requested ability can be requested to the another site 10, thereby enabling an improved production amount as an organization as a whole. Fourth Example Embodiment

FIG. 12 is a diagram illustrating an overview of an information processing apparatus 100 according to the present example embodiment. The information processing apparatus 100 includes a generation unit 102 and an output processing unit 104 that are the same as those in the information processing apparatus 100 according to the first example embodiment in FIG. 1 and further includes an estimation unit 110.

The present example embodiment is similar to one of the aforementioned example embodiments except for being configured to simulate an amount supplied from a site to a market and output a site at which the difference between the amount supplied and an amount demanded at the market satisfies a criterion as advice information. Note that the configuration according to the present example embodiment may be combined with at least one of configurations according to example embodiments other than the first example embodiment without contradicting each other.

### System Overview

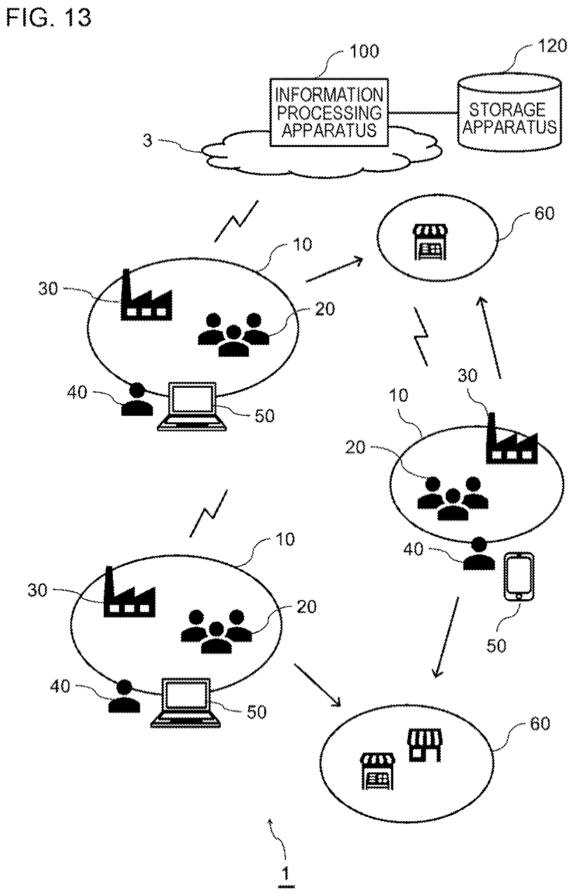

FIG. 13 is a diagram conceptually illustrating a system configuration of an information processing system 1 according to the present example embodiment.

The information processing system 1 according to the present example embodiment further includes at least one market 60 in addition to the configuration of the information processing system 1 in FIG. 3. The market 60 is a site to which a product produced at each site 10 is supplied.

### Functional Configuration Example

A functional configuration example of the information processing apparatus 100 according to the present example embodiment will be described below by using FIG. 12.

The generation unit 102 generates estimation information for each of a plurality of sites.

The estimation unit 110 estimates an amount supplied to a market 60 by using the position of the market 60 and the position of the site 10, and the estimation information.

The output processing unit 104 causes a site 10 at which the difference between the amount supplied to the market 60 and an amount demanded at the market 60 satisfies a criterion to be output as advice information.

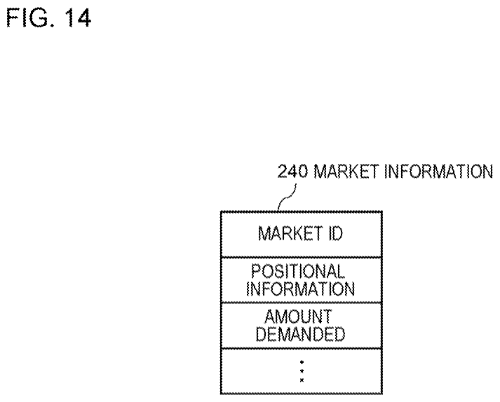

FIG. 14 is a diagram illustrating a data structure example of market information 240. The market information 240 includes identification information (a market ID) for identifying a market 60, positional information of the market 60, and an amount demanded at the market 60.

The positional information may be information indicating a location (such as an address or a region) of the market 60 or may be latitude-longitude.

For example, the amount demanded includes information such as a product name and a quantity required by the market 60, and a delivery date.

For example, the amount supplied to the market 60 includes information such as a suppliable quantity of products required by the market 60 and a delivery date. Furthermore, the amount demanded and the amount supplied may include information about a cost (or a price) incurred for providing the amount demanded and the amount supplied, respectively.

The storage apparatus 120 in the information processing apparatus 100 may further store cost information related to a cost incurred for production of each product for each site 10. The estimation unit 110 may estimate a cost or a price incurred for product supply required by the market 60 by further using the cost information and generate estimation information including information about the cost.

Furthermore, the output processing unit 104 may include information about an amount that can be supplied by the site 10, a delivery date, and the like in the advice information.

For example, as for the amount demanded at the market 60, input of information about a required item can be accepted from an input screen of an operation menu on a terminal 50. Examples of the input item may include information about a product name, a quantity, a delivery date, and a preferred price. As for the amount demanded by the market 60, an expected amount to be supplied to the market 60 may be set when a business plan is made or a sales material is prepared for the market 60, without being limited to a case of a request being actually made from the market 60.

For example, the criterion for the difference between an amount supplied to a market 60 and an amount demanded at the market 60 is that the difference satisfies a condition of being less than a threshold value. When the difference is evidently large, the estimation unit 110 may estimate amounts supplied to the market 60 by a plurality of sites 10 by using estimation information of the plurality of sites 10. When the amounts supplied to the market 60 by the plurality of sites 10 in total satisfy the amount demanded at the market 60, the output processing unit 104 may output the plurality of sites 10 as the advice information.

Further, the sites 10 may include sites 10 not belonging to the same enterprise. For example, in a case of a product produced by combining a plurality of parts, site information 210 about a site 10 of another enterprise manufacturing and supplying the part may be acquired from the site 10 and be stored into a storage apparatus 120. Furthermore, in a case of a product produced by using equipment 30 of another enterprise, site information 210 of a site 10 of the another enterprise providing the equipment 30 may be acquired from the site 10 and be stored into the storage apparatus 120.

The configuration enables improved productivity by efficiently using equipment 30, an employee 20, a material, and/or the like of another enterprise.

### Operation Example

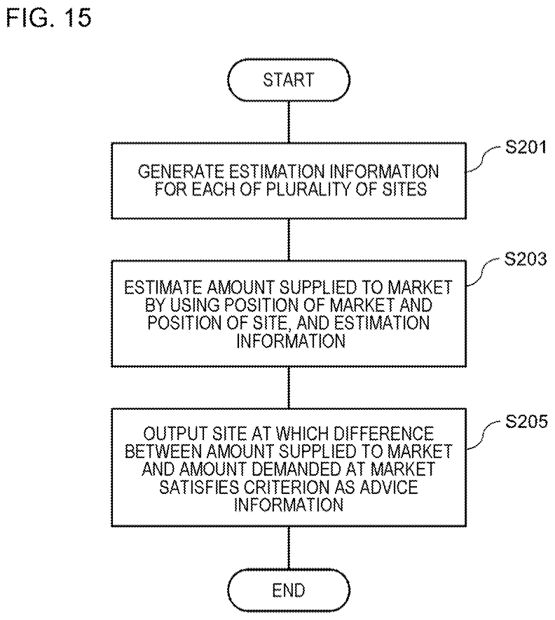

FIG. 15 is a flowchart illustrating an operation example of the information processing apparatus 100 according to the present example embodiment.

The generation unit 102 generates estimation information for each of a plurality of sites (Step S201).

The estimation unit 110 estimates an amount supplied to a market 60 by using the position of the market 60 and the position of the site 10, and the estimation information (Step S203).

The output processing unit 104 causes a site 10 at which the difference between the amount supplied to the market 60 and an amount demanded at the market 60 satisfies the criterion to be output as advice information (Step S205).

As described above, the generation unit 102 according to the present example embodiment generates estimation information for each of a plurality of sites. The estimation unit 110 estimates an amount supplied to a market 60 by using the position of the market 60 and the position of the site 10, and the estimation information. The output processing unit 104 causes a site 10 at which the difference between the amount supplied to the market 60 and an amount demanded at the market 60 satisfies the criterion to be output as advice information.

Thus, the present example embodiment provides effects similar to those of the aforementioned example embodiments and further enables determination of a site 10 at which supply satisfies demand of a market 60 and output of the site 10 as advice information, thereby facilitating examination of a business plan. Furthermore, a supply schedule can be provided to a market 60, and therefore the advice information can also be used in a sales activity.

### Fifth Example Embodiment

FIG. 16 is a diagram illustrating an overview of an information processing apparatus 100 according to the present example embodiment. The information processing apparatus 100 includes a generation unit 102 and an output processing unit 104 that are the same as those in the information processing apparatus 100 according to the first example embodiment in FIG. 1 and further includes an authentication unit 112.

The present example embodiment is similar to one of the aforementioned example embodiments except for being configured to perform behavior analysis and authentication of an employee by processing an image. The information processing apparatus 100 according to the present example embodiment has the same configuration as that according to the first example embodiment, and therefore a functional configuration example will be described by using FIG. 1. Note that the configuration according to the present example embodiment may be combined with at least one of configurations according to example embodiments other than the first example embodiment without contradicting each other.

### System Overview

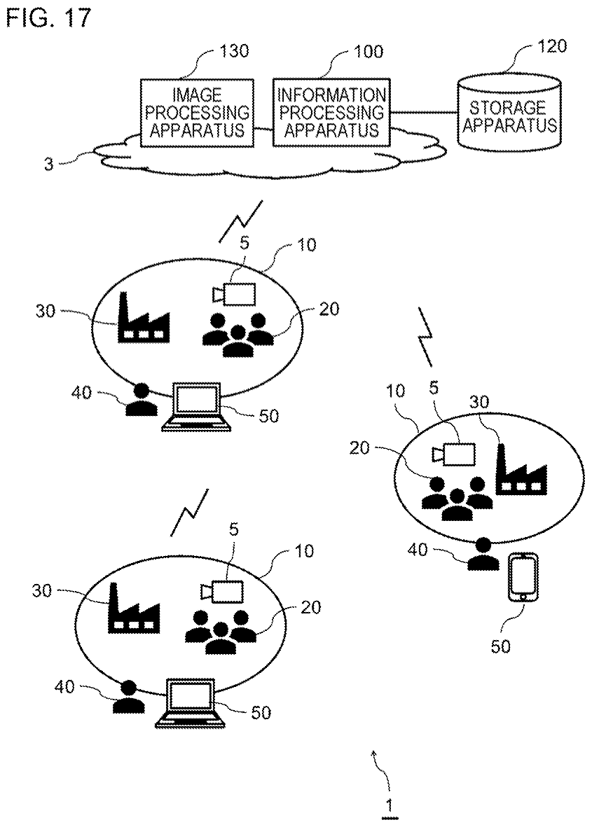

FIG. 17 is a diagram conceptually illustrating a system configuration of an information processing system 1 according to the example embodiment.

The information processing system 1 according to the present example embodiment further includes a camera 5 capturing images of equipment 30 and an employee 20 at each site 10, and an image processing apparatus 130 processing an image generated by the camera 5, in addition to the configuration of the information processing system 1 in FIG. 3.

The camera 5 includes a lens and an imaging element such as a charge coupled device (CCD) image sensor and is, for example, a network camera such as an internet protocol (IP) camera. For example, the network camera has a wireless local area network (LAN) communication function and is connected to the information processing apparatus 100 through a communication network 3, that is, a relaying apparatus (unillustrated) such as a router. Then, the camera 5 may include a mechanism for performing direction control of the camera body and/or the lens, zooming control, focusing, and the like by following movements of a person.

An image generated by the camera 5 may be captured in real time and be transmitted to the image processing apparatus 130 or may not be directly transmitted from the camera 5 and may be an image delayed by a predetermined time. Images captured by the camera 5 may be temporarily stored in another storage apparatus (unillustrated), and the image processing apparatus 130 may read the images from the storage apparatus sequentially or at predetermined time intervals. Furthermore, images transmitted to the image processing apparatus 130 may constitute a dynamic image, may be frame images separated at predetermined time intervals, or static images.

### Functional Configuration Example

A functional configuration example of the information processing apparatus 100 according to the present example embodiment will be described below by using FIG. 16.

The authentication unit 112 performs personal identification of an employee 20 operating equipment 30, by using biometric information of the employee 20.

The generation unit 102 acquires operation information about an operation result of the equipment 30 by the authenticated employee 20 and generates ability information of the employee 20.

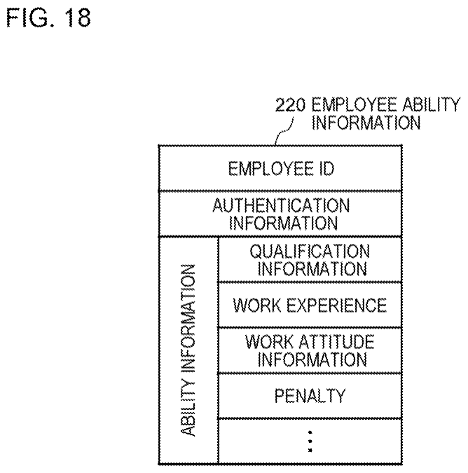

FIG. 18 is a diagram illustrating a data structure example of employee ability information 220. The employee ability information 220 according to the present example embodiment further includes authentication information of the employee 20 in addition to the employee ability information 220 in FIG. 6A. The authentication information is biometric information including feature information of a facial image of the employee 20. The authentication information may be another type of biometric information and for example, may include feature information of at least one of an iris, a vein, a pinna, a fingerprint, the gait, the body-build (such as the height, the width of the shoulders, the stature, or the skeleton). Further, a plurality of pieces of information may be combined.

The authentication unit 112 extracts feature information from a facial image of an employee 20 captured by the camera 5 and checks the extracted feature information against authentication information stored (registered) in the employee ability information 220. When a degree of match between the extracted feature information and the registered authentication information is equal to or greater than a threshold value, the image is authenticated to be the employee 20. Note that the image processing is performed by the image processing apparatus 130.

By processing an image of an employee 20 at work, the generation unit 102 generates operation information of the employee 20 and generates ability information of the employee 20 by using the generated operation information.

For example, in a case of equipment 30 at which production is manually performed by an employee 20, the operation information may include information indicating a measured time required for work in each process determined by image processing, or the like for each employee 20. Furthermore, the operation information may include information indicating validity of a work procedure (such as whether the work procedure is correct) and a quality level of a work content (such as accuracy of the work) that are determined by performing behavior analysis of the employee 20 by image processing.

### Operation Example

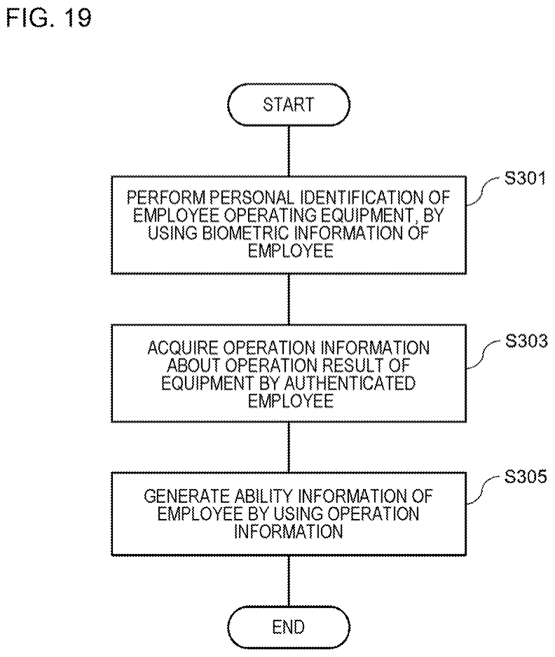

FIG. 19 is a flowchart illustrating an operation example of the information processing apparatus 100 according to the present example embodiment.

The authentication unit 112 performs personal identification of an employee 20 operating equipment 30, by using biometric information of the employee 20 (Step S301).

The generation unit 102 acquires operation information about an operation result of the equipment 30 by the authenticated employee 20 (Step S303). The generation unit 102 generates ability information of the employee 20 by using the operation information (Step S305).

As described above, the information processing apparatus 100 according to the present example embodiment further includes the authentication unit 112. The authentication unit 112 performs personal identification of an employee 20 operating equipment 30, by using biometric information of the employee 20. The generation unit 102 acquires operation information about an operation result of the equipment 30 by the authenticated employee 20 and generates ability information of the employee 20.

Thus, the present example embodiment provides effects similar to those of the aforementioned example embodiments and further enables generating ability information of an employee 20 operating equipment 30, based on operation information of the employee 20 personally identified by using biometric information of the employee 20, thereby enabling prevention of an improper act such as proxy and estimation of highly reliable ability information.

While the example embodiments have been described above with reference to the drawings, the example embodiments are exemplifications, and various configurations other than those described above may be employed.

### Other Example Embodiments

For example, advice information may include information of a plurality of other sites 10. Then, the manager 40 may be able to select another site to which assistance is requested after weighing the pieces of information of the plurality of other sites 10 against each other. The output processing unit 104 may cause the terminal 50 to display a screen including a user interface (UI) accepting selection of another site 10 to which assistance is requested, accept a selection operation by the manager 40, and transmit an assistance request to the terminal 50 at the selected another site 10.

As for an assistance request, a message including the content of the assistance request may be transmitted to the terminal 50 by mail, short message service (SMS), or the like. Alternatively, the terminal 50 may display notification of existence of an assistance request from another site 10 and the content of the assistance request through a notification screen on a web page of the information processing system 1 by an application or a browser.

Further, estimation information is generated based on equipment 30 and an employee 20 at each site 10, according to the aforementioned example embodiments. Furthermore, information about energy supply/demand usable for operation of equipment 30 at each site 10 may be used in generation of estimation information. For example, the information about energy supply/demand includes information such as an energy type [for example, fuel (such as natural gas or petroleum) or electric power (such as thermal power, hydraulic power, atomic power, or natural energy)] usable at the site 10 and an expected amount of energy supply/demand. Furthermore, the information about energy supply/demand may include information about a cost incurred by energy procurement.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

Note that, when information about a user (such as an employee 20) is acquired and used in the example embodiments, the acquisition and the use are assumed to be performed legally.

Further, while a plurality of processes (processing) are described in a sequential order in each of a plurality of flowcharts used in the aforementioned description, the execution order of processes executed in each example embodiment is not limited to the order of description. The order of the illustrated processes may be modified without affecting the contents in each example embodiment. Further, the aforementioned example embodiments may be combined without contradicting each another.

The whole or part of the example embodiments disclosed above may also be described as, but not limited to, the following supplementary notes.

1. An information processing apparatus including:
a generation unit that, for at least one of a plurality of sites, generates estimation information indicating estimated ability of the site by using ability information of an employee at the site and equipment information about equipment at the site; and
an output processing unit that generates advice information to a manager of the site by using the estimation information and request information indicating ability requested with regard to the site and causing an output unit to output the generated advice information.
   2. The information processing apparatus according to 1., wherein
the ability information of an employee at the site and the equipment information at the site are stored in a storage unit for each of the plurality of sites,
the generation unit generates estimation information of another site by using information stored in the storage unit when estimated ability indicated by the estimation information of a certain site falls short of ability being requested of the certain site and being indicated by the request information, and
the output processing unit causes the estimation information of the another site to be output as at least part of the advice information.
   3. The information processing apparatus according to 2., further including
a determination unit that determines the another site to be added that can provide assistance to the certain site, based on the request information of the certain site and the estimation information of the another site, wherein
the output processing unit causes information about the determined another site to be output as at least part of the advice information.
   4. The information processing apparatus according to 3., wherein
the determination unit determines the another site to be added that can provide the assistance to the certain site by further using a relationship between the sites.
   5. The information processing apparatus according to any one of 1. to 4., wherein
the generation unit generates the estimation information for each of a plurality of sites,
the information processing apparatus further includes an estimation unit that estimates an amount supplied to a market by using a position of the market and a position of the site, and the estimation information, and
the output processing unit causes a site at which a difference between the amount supplied to the market and an amount demanded at the market satisfies a criterion to be output as the advice information.
   6. The information processing apparatus according to any one of 1. to 5., wherein
ability information of the employee includes information indicating a qualification possessed by the employee (including, for each piece of equipment, information indicating whether the employee can operate the equipment), and
the equipment information includes information indicating a production amount, a defective rate, and a security level of the equipment.
   7. The information processing apparatus according to any one of 1. to 6., wherein the equipment information of the each site includes a type of apparatus constituting the equipment and information about a product manufactured by the equipment.
   8. The information processing apparatus according to any one of 1. to 7., further including
an authentication unit that performs personal identification of the employee operating the equipment, by using biometric information of the employee, wherein
the generation unit acquires operation information about an operation result of the equipment by the authenticated employee and generates ability information of the employee.
   9. The information processing apparatus according to 8., wherein
the generation unit generates the operation information of the employee by processing an image of the employee at work and generates the ability information of the employee by using the generated operation information.
   10. An information processing method including, by at least one computer:
for at least one of a plurality of sites, generating estimation information indicating estimated ability of the site by using ability information of an employee at the site and equipment information about equipment at the site; and
generating advice information to a manager of the site by using the estimation information and request information indicating ability requested with regard to the site and causing an output unit to output the generated advice information.
   11. The information processing method according to 10., wherein
the ability information of an employee at the site and the equipment information at the site are stored in a storage unit for each of the plurality of sites, and
the information processing method further includes, by the at least one computer:
   generating estimation information of another site by using information stored in the storage unit when estimated ability indicated by the estimation information of a certain site falls short of ability being requested of the certain site and being indicated by the request information; and
   causing the estimation information of the another site to be output as at least part of the advice information.
      12. The information processing method according to 11., further including, by the at least one computer:
determining the another site to be added that can provide assistance to the certain site, based on the request information of the certain site and the estimation information of the another site; and
causing information about the determined another site to be output as at least part of the advice information.
   13. The information processing method according to 12., further including, by the at least one computer,
determining the another site to be added that can provide the assistance to the certain site by further using a relationship between the sites.
   14. The information processing method according to any one of 10. to 13., further including, by the at least one computer:
generating the estimation information for each of a plurality of sites;
estimating an amount supplied to a market by using a position of the market and a position of the site, and the estimation information; and
causing a site at which a difference between the amount supplied to the market and an amount demanded at the market satisfies a criterion to be output as the advice information.
   15. The information processing method according to any one of 10. to 14., wherein
ability information of the employee includes information indicating a qualification possessed by the employee (including, for each piece of equipment, information indicating whether the employee can operate the equipment), and
the equipment information includes information indicating a production amount, a defective rate, and a security level of the equipment.
   16. The information processing method according to any one of 10. to 15., wherein
the equipment information of the each site includes a type of apparatus constituting the equipment and information about a product manufactured by the equipment.
   17. The information processing method according to any one of 10. to 16., further including, by the at least one computer:
performing personal identification of the employee operating the equipment, by using biometric information of the employee; and
acquiring operation information about an operation result of the equipment by the authenticated employee and generating ability information of the employee.
   18. The information processing method according to 17., further including, by the at least one computer,
generating the operation information of the employee by processing an image of the employee at work and generating the ability information of the employee by using the generated operation information.
   19. A program for causing a computer to execute:
a procedure for, for at least one of a plurality of sites, generating estimation information indicating estimated ability of the site by using ability information of an employee at the site and equipment information about equipment at the site; and
a procedure for generating advice information to a manager of the site by using the estimation information and request information indicating ability requested with regard to the site and causing an output unit to output the generated advice information.
   20. The program according to 19., wherein
the ability information of an employee at the site and the equipment information at the site are stored in a storage unit for each of the plurality of sites, and
the computer,
   in the procedure for generation, generates estimation information of another site by using information stored in the storage unit when estimated ability indicated by the estimation information of a certain site falls short of ability being requested of the certain site and being indicated by the request information and,
   in the procedure for causing output, causes the estimation information of the another site to be output as at least part of the advice information.
      21. The program according to 20., further causing the computer to execute
a procedure for determining the another site to be added that can provide assistance to the certain site, based on the request information of the certain site and the estimation information of the another site, wherein,
in the procedure for causing output, the computer causes information about the determined another site to be output as at least part of the advice information.
   22. The program according to 21., wherein
the computer, in the procedure for determination, determines the another site to be added that can provide the assistance to the certain site by further using a relationship between the sites.
   23. The program according to any one of 19. to 22., wherein
the computer, in the procedure for generation, generates the estimation information for each of a plurality of sites,
the program further causes the computer to execute a procedure for estimating an amount supplied to a market by using a position of the market and a position of the site, and the estimation information, and
the computer, in the procedure for causing output, causes a site at which a difference between the amount supplied to the market and an amount demanded at the market satisfies a criterion to be output as the advice information.
   24. The program according to any one of 19. to 23., wherein
ability information of the employee includes information indicating a qualification possessed by the employee (including, for each piece of equipment, information indicating whether the employee can operate the equipment), and
the equipment information includes information indicating a production amount, a defective rate, and a security level of the equipment.
   25. The program according to any one of 19. to 24., wherein
the equipment information of the each site includes a type of apparatus constituting the equipment and information about a product manufactured by the equipment.
   26. The program according to any one of 19. to 25., further causing the computer to execute
a procedure for performing personal identification of the employee operating the equipment, by using biometric information of the employee, wherein
the computer, in the procedure for generation, acquires operation information about an operation result of the equipment by the authenticated employee and generates ability information of the employee.
   27. The program according to 26., wherein
the computer, in the procedure for generation, generates the operation information of the employee by processing an image of the employee at work and generates the ability information of the employee by using the generated operation information.
   28. A computer-readable storage medium on which a program is stored, the program causing a computer to execute:
a procedure for, for at least one of a plurality of sites, generating estimation information indicating estimated ability of the site by using ability information of an employee at the site and equipment information about equipment at the site; and
a procedure for generating advice information to a manager of the site by using the estimation information and request information indicating ability requested with regard to the site and causing an output unit to output the generated advice information.
   29. The computer-readable storage medium on which the program is stored according to 28., wherein
the ability information of an employee at the site and the equipment information at the site are stored in a storage unit for each of the plurality of sites, and
the computer,
   in the procedure for generation, generates estimation information of another site by using information stored in the storage unit when estimated ability indicated by the estimation information of a certain site falls short of ability being requested of the certain site and being indicated by the request information and,
   in the procedure for causing output, causes the estimation information of the another site to be output as at least part of the advice information.
      30. The computer-readable storage medium on which the program is stored according to 29., further causing the computer to execute
a procedure for determining the another site to be added that can provide assistance to the certain site, based on the request information of the certain site and the estimation information of the another site, wherein
the computer, in the procedure for causing output, causes information about the determined another site to be output as at least part of the advice information.
   31. The computer-readable storage medium on which the program is stored according to 30., wherein
the computer, in the procedure for determination, determines the another site to be added that can provide the assistance to the certain site by further using a relationship between the sites.
   32. The computer-readable storage medium on which the program is stored according to any one of 28. to 31., wherein
the computer, in the procedure for generation, generates the estimation information for each of a plurality of sites,
the program further causes the computer to execute a procedure for estimating an amount supplied to a market by using a position of the market and a position of the site, and the estimation information, and
the computer, in the procedure for causing output, causes a site at which a difference between the amount supplied to the market and an amount demanded at the market satisfies a criterion to be output as the advice information.
   33. The computer-readable storage medium on which the program is stored according to any one of 28. to 32., wherein
ability information of the employee includes information indicating a qualification possessed by the employee (including, for each piece of equipment, information indicating whether the employee can operate the equipment), and
the equipment information includes information indicating a production amount, a defective rate, and a security level of the equipment.
   34. The computer-readable storage medium on which the program is stored according to any one of 28. to 33., wherein
the equipment information of the each site includes a type of apparatus constituting the equipment and information about a product manufactured by the equipment.
   35. The computer-readable storage medium on which the program is stored according to any one of 28. to 34., further causing the computer to execute
a procedure for performing personal identification of the employee operating the equipment, by using biometric information of the employee, wherein
the computer, in the procedure for generation, acquires operation information about an operation result of the equipment by the authenticated employee and generates ability information of the employee.
   36. The computer-readable storage medium on which the program is stored according to 35., wherein
the computer, in the procedure for generation, generates the operation information of the employee by processing an image of the employee at work and generates the ability information of the employee by using the generated operation information.

1. An information processing apparatus comprising:
at least one memory configured to store instructions; and
at least one processor configured to execute the instructions to:
for at least one of a plurality of sites, generate estimation information indicating estimated ability of the site by using ability information of an employee at the site and equipment information about equipment at the site; and
generate advice information to a manager of the site by using the estimation information and request information indicating ability requested with regard to the site and cause an output unit to output the generated advice information.

2. The information processing apparatus according to claim 1, wherein
the ability information of an employee at the site and the equipment information at the site are stored in a storage unit for each of the plurality of sites,
the at least one processor is further configured to execute the instructions to:
generate estimation information of another site by using information stored in the storage unit when estimated ability indicated by the estimation information of a certain site falls short of ability being requested of the certain site and being indicated by the request information; and
cause the estimation information of the another site to be output as at least part of the advice information.

3. The information processing apparatus according to claim 2, wherein
the at least one processor is further configured to execute the instructions to:
determine the another site to be added that can provide assistance to the certain site, based on the request information of the certain site and the estimation information of the another site; and
cause information about the determined another site to be output as at least part of the advice information.

4. The information processing apparatus according to claim 3, wherein
the at least one processor is further configured to execute the instructions to
determine the another site to be added that can provide the assistance to the certain site by further using a relationship between the sites.

5. The information processing apparatus according to claim 1, wherein
the at least one processor is further configured to execute the instructions to:
generate the estimation information for each of a plurality of sites;
estimate an amount supplied to a market by using a position of the market and a position of the site, and the estimation information; and
cause a site at which a difference between the amount supplied to the market and an amount demanded at the market satisfies a criterion to be output as the advice information.

6. The information processing apparatus according to claim 1, wherein
ability information of the employee includes information indicating a qualification possessed by the employee, and
the equipment information includes information indicating a production amount, a defective rate, and a security level of the equipment.

7. The information processing apparatus according to claim 1, wherein
the equipment information of the each site includes a type of apparatus constituting the equipment and information about a product manufactured by the equipment.

8. The information processing apparatus according to claim 1, wherein
the at least one processor is further configured to execute the instructions to:
perform personal identification of the employee operating the equipment, by using biometric information of the employee; and
acquire operation information about an operation result of the equipment by the authenticated employee and generate ability information of the employee.

9. The information processing apparatus according to claim 8, wherein
the at least one processor is further configured to execute the instructions to:
generate the operation information of the employee by processing an image of the employee at work and generates the ability information of the employee by using the generated operation information.

10. An information processing method comprising, by at least one computer:
for at least one of a plurality of sites, generating estimation information indicating estimated ability of the site by using ability information of an employee at the site and equipment information about equipment at the site; and
generating advice information to a manager of the site by using the estimation information and request information indicating ability requested with regard to the site and causing output unit to output the generated advice information.

11. The information processing method according to claim 10, wherein
the ability information of an employee at the site and the equipment information at the site are stored in a storage unit for each of the plurality of sites,
the information processing method further comprises, by the at least one computer:
generating estimation information of another site by using information stored in the storage unit when estimated ability indicated by the estimation information of a certain site falls short of ability being requested of the certain site and being indicated by the request information; and
causing the estimation information of the another site to be output as at least part of the advice information.

12. The information processing method according to claim 11, wherein
the information processing method further comprises, by the at least one computer:
determining the another site to be added that can provide assistance to the certain site, based on the request information of the certain site and the estimation information of the another site; and
causing information about the determined another site to be output as at least part of the advice information.

13. The information processing method according to claim 12, wherein
the information processing method further comprises, by the at least one computer
determining the another site to be added that can provide the assistance to the certain site by further using a relationship between the sites.

14. The information processing method according to claim 10, wherein
the information processing method further comprises, by the at least one computer:
generating the estimation information for each of a plurality of sites;
estimating an amount supplied to a market by using a position of the market and a position of the site, and the estimation information; and
causing a site at which a difference between the amount supplied to the market and an amount demanded at the market satisfies a criterion to be output as the advice information.

15. A non-transitory computer-readable storage medium storing a program for causing a computer to execute:
a procedure for, for at least one of a plurality of sites, generating estimation information indicating estimated ability of the site by using ability information of an employee at the site and equipment information about equipment at the site; and
a procedure for generating advice information to a manager of the site by using the estimation information and request information indicating ability requested with regard to the site and causing an output unit to output the generated advice information.

16. The non-transitory computer-readable storage medium according to claim 15, wherein
the ability information of an employee at the site and the equipment information at the site are stored in a storage unit for each of the plurality of sites,
the program causes the computer to execute:
a procedure for generating estimation information of another site by using information stored in the storage unit when estimated ability indicated by the estimation information of a certain site falls short of ability being requested of the certain site and being indicated by the request information; and
a procedure for causing the estimation information of the another site to be output as at least part of the advice information.

17. The non-transitory computer-readable storage medium according to claim 16, wherein
the program causes the computer to execute:
a procedure for determining the another site to be added that can provide assistance to the certain site, based on the request information of the certain site and the estimation information of the another site; and
a procedure for causing information about the determined another site to be output as at least part of the advice information.

18. The non-transitory computer-readable storage medium according to claim 17, wherein
the program causes the computer to execute
a procedure for determining the another site to be added that can provide the assistance to the certain site by further using a relationship between the sites.

19. The non-transitory computer-readable storage medium according to claim 15, wherein
the program causes the computer to execute:
a procedure for generating the estimation information for each of a plurality of sites;
a procedure for estimating an amount supplied to a market by using a position of the market and a position of the site, and the estimation information; and
a procedure for causing a site at which a difference between the amount supplied to the market and an amount demanded at the market satisfies a criterion to be output as the advice information.
